(19) United States
(12) Patent Application Publication
(10) Pub. No.: US 2006/0170855 A1
(43) Pub. Date: Aug. 3, 2006

(54) Liquid crystal display panel and fabrication method thereof

(75) Inventors: Jung-Hsiang Lin, Taichung City (TW); Jen-Lang Tung, Kaohsiung City (TW); Hao-Yu Chang, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/147,101

(22) Filed: Jun. 7, 2005

(30) Foreign Application Priority Data
Jan. 31, 2005 (TW) 94102866

(51) Int. Cl. G02F 1/1339

(52) U.S. Cl. 349/155

(57) ABSTRACT

A liquid crystal display panel and a fabrication method thereof are provided. The liquid crystal display panel includes a first substrate and a second substrate disposed opposite the first substrate. A liquid crystal layer and a thermosetting spacer are disposed between the first substrate and the second substrate.

### BACKGROUND

The invention relates to a liquid crystal display panel and the fabrication method thereof, in particular to a liquid crystal display panel having a thermosetting spacer and fabrication method thereof.

FIG. 1 is a cross section of a liquid crystal display panel comprising a first substrate 12 and a second substrate 14. The substrate may be a color filter (CF) substrate or thin film transistor (TFT) substrate. A plurality of spacers 18 are disposed between the first substrate 12 and the second substrate 14, such that liquid crystal 16 can be interposed therebetween.

One drop fill (ODF) as shown in FIG. 2A˜2C is a popular technique for liquid crystal display panel fabrication methods. In FIG. 2A, sealant 13 is applied on the periphery of substrate 12. Liquid crystal 16 is dropped onto the substrate 12 and second substrate 14 is assembled with first substrate 12 in vacuum as shown in FIG. 2B. After returning to atmosphere pressure, the two substrates 12 and 14 are assembled automatically to form a liquid crystal display panel, as shown in FIG. 2C. Spacers 18 as shown in FIG. 1 can be disposed on either color filter (CF) substrate or thin film transistor (TFT) substrate. The amount of liquid crystal used is defined by the interior space of the substrate assembly. Accordingly, before dropping the liquid crystal, the spacer between two substrates, the height, volume, and numbers of the spacer must be ascertained.

However, with the current ODF process, LC quantity is difficult to match the interior space because of the deviation of spacer height or the LC quantity accuracy. Vacuum bubble or bulge will happen because of mismatch of LC quantity and internal space. Bubbles easily form when the amount of liquid crystal is inaccurate or the spacer height shifts. Bubble formation deteriorates liquid crystal display panel performance.

One way to minimize the bubble problem is to use softer spacers to improve the LC margin; interior space with softer spacer will be compressed under atmospheric pressure if fewer liquid crystal is dropped. But the compressive resistance of the liquid crystal display panel decreases accordingly.

### SUMMARY

Accordingly, embodiments of the invention provide a liquid crystal display panel and a fabrication method thereof.

In an embodiment of the invention, a fabrication method for a liquid crystal display panel comprises providing a first substrate and forming a thermosetting spacer thereon. A second substrate is provided and assembled with the first substrate. The thermosetting spacer is cured by a thermal treatment.

In another embodiment, a liquid crystal display panel includes a first substrate and a second substrate oppositely disposed the first substrate. A liquid crystal layer and a thermosetting spacer are disposed between the first substrate and the second substrate.

### DESCRIPTION OF THE DRAWINGS

The embodiments can be more fully understood by reading the subsequent detailed description and examples with references made to the accompanying drawings, wherein:

FIG. 1 is a cross section illustrating a conventional liquid crystal display panel structure.

FIGS. 2A˜2C are elevational view illustrating a fabrication process of a conventional liquid crystal display panel.

FIGS. 3A˜3C are cross sections illustrating a fabrication process of a liquid crystal display panel of the first embodiment of the invention.

FIGS. 4A˜4C are cross sections illustrating a fabrication process of a liquid crystal display panel of the second embodiment of the invention.

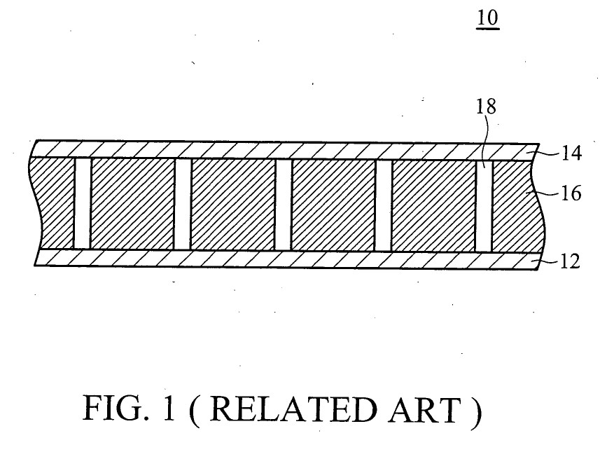

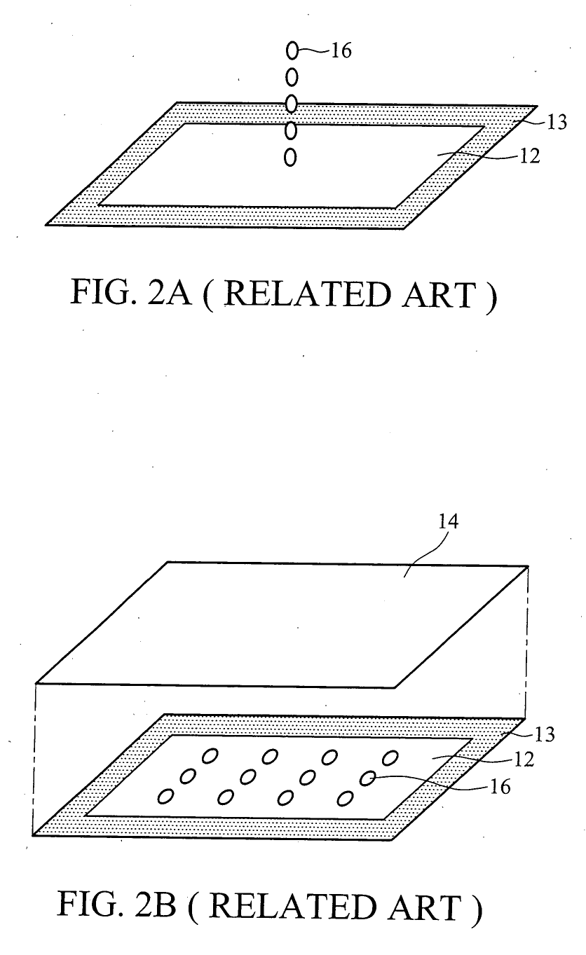

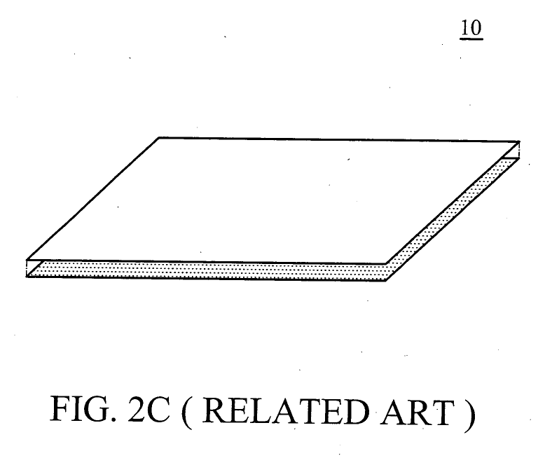

### DETAILED DESCRIPTION

### First Embodiment

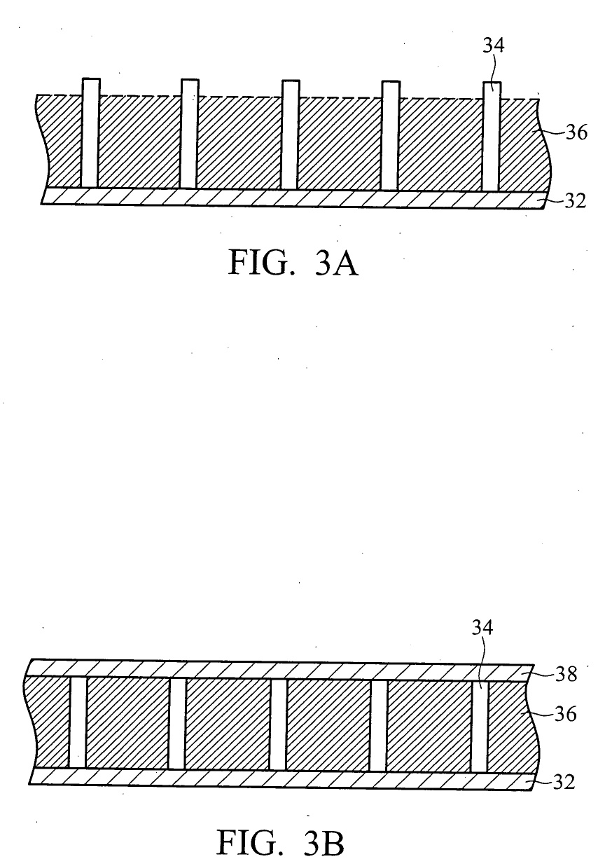

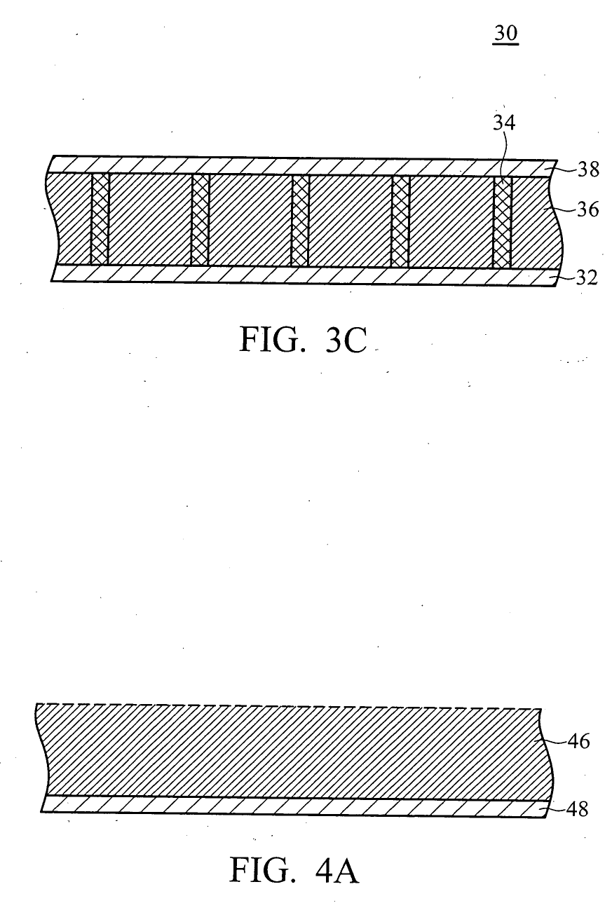

FIGS. 3A˜3C are cross sections illustrating a fabrication process of liquid crystal display panel 30 of the first embodiment of the invention. In this embodiment, a thermosetting spacer is formed on a substrate and a liquid crystal is dropped on the substrate. Another substrate is assembled with the substrate.

In FIG. 3A, first substrate 32 is provided and may be a thin film transistor (TFT) substrate or a color filter substrate, made up of a glass substrate or an indium tin oxide (ITO) substrate.

Thermosetting spacer 34 is formed on first substrate 32 by etching process or ink jet printing. The temperature for forming thermosetting spacer 34 must be lower than the curing temperature of the thermosetting spacer 34 to avoid curing. Thermosetting spacer 34 may be polymer, such as acrylic material. The thickness of thermosetting spacer 34 is related to the amount of liquid crystal, usually 2˜5 μm. Thermosetting spacer 34 may be pillar-shaped.

First substrate 32 is put in vacuum environment and liquid crystal 36 dropped thereon. This step can also be executed before thermosetting spacer 34 is formed on first substrate 32.

In FIG. 3B, second substrate 38 is provided and is a thin film transistor (TFT) substrate or a color filter substrate, made up of a glass substrate or an indium tin oxide (ITO) substrate. Second substrate 38 may be assembled with first substrate 32 in a vacuum environment. When process pressure returns to atmosphere pressure, the space between first substrate 32 and second substrate 38 decreases due to the increased pressure and since the spacer 34 is not cured yet, it deforms to fill the free space. As a consequence bubbles or voids may be eliminated or minimized and the process window of the ODF process is thereby increased.

In FIG. 3C, thermosetting spacer 34 is cured by thermal treatment, at lower than 250° C. to avoid device degradation. The cured thermosetting spacer 34 has a compressive strength larger than about 3 kg/cm² and a permanent deformation less than about 0.1 μm satisfying the compression resistance of liquid crystal display panel 30.

### Second Embodiment

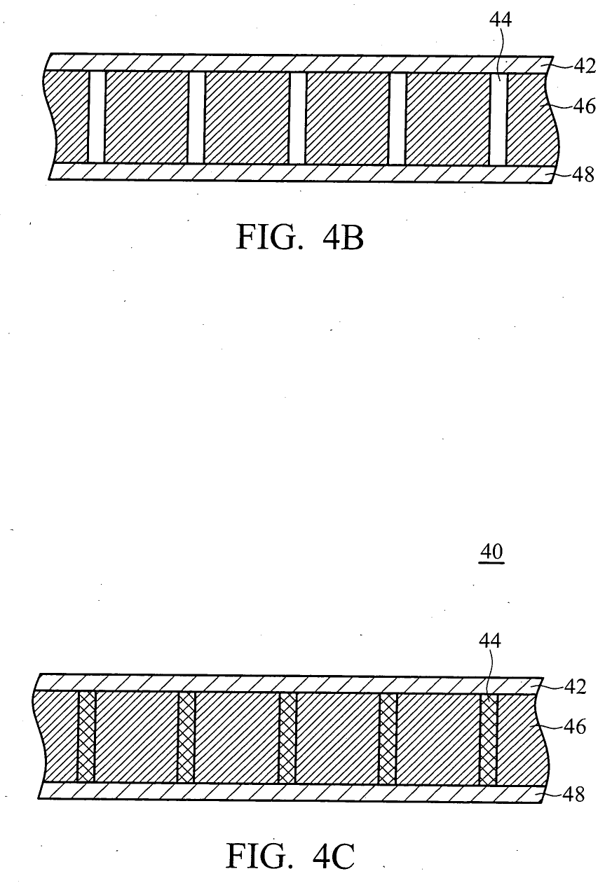

FIGS. 4Aμ4C are cross sections illustrating a fabrication process of liquid crystal display panel 40 of the second embodiment of the invention. In this embodiment, liquid crystal is dropped on a substrate having no thermosetting spacer thereon. Then, the substrate is assembled with another substrate having a thermosetting spacer thereon.

In FIG. 4A, second substrate 48 is provided and may be a thin film transistor (TFT) substrate or a color filter substrate, made from a glass substrate or an indium tin oxide (ITO) substrate.

Liquid crystal 46 is dropped on second substrate 48 in a vacuum environment.

First substrate 42 may be a thin film transistor (TFT) substrate or a color filter substrate, made up of a glass substrate or an indium tin oxide (ITO) substrate.

Thermosetting spacer 44 is formed on first substrate 42 by etching or ink jet printing. The temperature for forming thermosetting spacer 44 must be lower than the curing temperature of the thermosetting spacer 44 to avoid curing. Thermosetting spacer 44 may be polymer, such as acrylic material. The thickness of thermosetting spacer 44, depending on the amount of liquid crystal, may be about 2μ5 μm. Thermosetting spacer 44 may be pillar-shaped.

First substrate 42 is assembled with second substrate 48 in a vacuum environment. When the process pressure returns to atmosphere pressure, the space between second substrate 48 and first substrate 42 decreases due to the increased pressure and since the spacer 44 is not cured yet, it deforms to fill the free space. In consequence the bubbles or voids may be eliminated or minimized and the process window of the ODF process thereby increased.

In FIG. 4C, thermosetting spacer 44 is cured by thermal treatment, and the temperature of the thermal treatment may be lower than about 250° C. to avoid device degradation. The cured thermosetting spacer 44 has a compressive strength about 3˜10 kg/cm² and a permanent deformation less than about 0.1 μm satisfying the compression resistance of liquid crystal display panel 40.

The present invention further provides a liquid crystal display panel, comprising a first substrate, a second substrate disposed opposite to the first substrate, a liquid layer disposed between the first and second substrate, and a plurality of thermosetting spacers disposed between the first and second substrate.

After thermal treatment, the cross-linkage density and hardness of the thermosetting spacer of the present invention, such as acrylic thermosetting materials, increase. During ODF and assemblage process, the uncured thermosetting spacer is relatively soft to the cured thermosetting spacer, and can be deformed to reduce vacuum bubbles. After assembling, the thermosetting spacer is cured by thermal treatment to increase its hardness and compression resistance. In short, the thermosetting spacer during ODF process is softer than the thermosetting spacer after assembling process, thus decreasing vacuum bubble without sacrificing compression resistance of liquid crystal display panel.

While the invention has been described by way of example and in terms of preferred embodiment, it is to be understood that the invention is not limited thereto. To the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A fabrication method for a liquid crystal display panel, comprising:
providing a first substrate;
forming at least one thermosetting spacer on the first substrate;
providing a second substrate;
assembling the first substrate and the second substrate; and
curing the thermosetting spacer.

2. The method as claimed in claim 1, wherein the first substrate is a thin film transistor substrate.

3. The method as claimed in claim 1, wherein the second substrate is a color filter substrate.

4. The method as claimed in claim 1, wherein the thermosetting spacer comprises polymer.

5. The method as claimed in claim 1, wherein the thermosetting spacer comprises acrylic material.

6. The method as claimed in claim 1, wherein the thickness of the thermosetting spacer is about 2˜5 μm.

7. The method as claimed in claim 1, wherein the thermosetting spacer is pillar-shaped.

8. The method as claimed in claim 1, wherein curing the thermosetting spacer comprises curing the thermosetting spacer by a thermal treatment with a temperature less than about 250° C.

9. The method as claimed in claim 1, further comprising disposing liquid crystal between the first substrate and the second substrate.

10. The method as claimed in claim 9, wherein disposing liquid crystal between the first substrate and the second substrate is one drop fill method (ODF).

11. The method as claimed in claim 9, wherein disposing liquid crystal between the first substrate and the second substrate is before forming the at least one thermosetting spacer on the first substrate.

12. The method as claimed in claim 9, wherein disposing liquid crystal between the first substrate and the second substrate is after forming the at least one thermosetting spacer on the first substrate.

13. A liquid crystal display panel, comprising:
a first substrate;
a second substrate disposed opposite to the first substrate;
a liquid crystal layer disposed between the first substrate and the second substrate; and
a plurality of thermosetting spacers disposed between the first substrate and the second substrate.

14. The liquid crystal display panel as claimed in claim 13, wherein the first substrate is a thin film transistor substrate.

15. The liquid crystal display panel as claimed in claim 13, wherein the second substrate is a color filter substrate.

16. The liquid crystal display panel as claimed in claim 13, wherein the at least one thermosetting spacer comprises polymer.

17. The liquid crystal display panel as claimed in claim 13, wherein the at least one thermosetting spacer comprises acrylic material.

18. The liquid crystal display panel as claimed in claim 13, wherein the thickness of the at least one thermosetting spacer is about 2˜5 μm.

19. The liquid crystal display panel as claimed in claim 13, wherein the at least one thermosetting spacer is pillar-shaped.

20. The liquid crystal display panel as claimed in claim 13, wherein the at least one thermosetting spacer has a compressive strength larger than about 3 kg/cm².

21. The liquid crystal display panel as claimed in claim 13, wherein the at least one thermosetting spacer has permanent deformation less than about 0.1 μm.
